(19) United States
(12) Patent Application Publication
(10) Pub. No.: US 2025/0372835 A1
(43) Pub. Date: Dec. 4, 2025

(54) ELECTRODE PLATE, SECONDARY BATTERY INCLUDING SAME, AND METHOD OF MANUFACTURING ELECTRODE PLATE

(71) Applicant: SAMSUNG SDI CO., LTD., Yongin-Si (KR)

(72) Inventors: Seung-Young PARK, Yongin-Si (KR); Gwijae KIM, Yongin-Si (KR); Jae Gyun DOO, Yongin-Si (KR)

(21) Appl. No.: 19/006,680

(22) Filed: Dec. 31, 2024

(30) Foreign Application Priority Data
Jun. 4, 2024 (KR) 10-2024-0073351

(51) Int. Cl. H01M 50/536; H01M 4/70; H01M 50/534; H01M 50/586; H01M 50/595

(52) U.S. Cl. CPC H01M 50/536; H01M 4/70; H01M 50/534; H01M 50/586; H01M 50/595

(57) ABSTRACT

An electrode plate includes: a composite portion including an active material applied to a substrate; an uncoated portion in which no active material is applied to the substrate; and a tab coupled to the uncoated portion. The uncoated portion has an open area, and at least a portion of the tab overlaps with the open area.

### CROSS REFERENCE TO RELATED APPLICATION

The present application claims priority to and the benefit of Korean Patent Application No. 10-2024-0073351, filed on Jun. 4, 2024, in the Korean Intellectual Property Office, the entire disclosure of which is incorporated by reference herein.

### BACKGROUND

### 1. Field

Aspects of embodiments of the present disclosure relate to an electrode plate, a secondary battery including the electrode plate, and a method of manufacturing the electrode plate.

### 2. Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

To connect an electrode terminal to an electrode assembly, a metal tab, for example, made of nickel or aluminum, is welded to an uncoated portion of an electrode plate that is not coated with an active material. However, in a case where the active material expands and increases, stress within the electrode assembly may be caused due to charging and discharging.

The above information disclosed in this Background section is for enhancement of understanding of the background of the present disclosure, and therefore, it may contain information that does not constitute related (or prior) art.

### SUMMARY

The stress may be concentrated near the metal tab due to a stepped portion of the metal tab that is bonded to the uncoated portion. In this case, because the strength of the metal tab may be higher than that of a substrate due to a thickness thereof, the stress may be concentrated at corners of the metal tab, thereby causing cracks in the electrode plate. As a result, an electrode assembly may be deformed, and a short circuit may occur, thereby reducing the safety and the reliability of the secondary battery.

Embodiments of the present disclosure may be directed to an electrode plate, a secondary battery including the electrode plate, and method for manufacturing the electrode plate.

These and other aspects and features of the present disclosure will be described in or will be apparent from the following description of embodiments of the present disclosure.

According to one or more embodiments of the present disclosure, an electrode plate includes: a composite portion including an active material applied to a substrate; an uncoated portion in which no active material is applied to the substrate; and a tab coupled to the uncoated portion. The uncoated portion has an open area, and at least a portion of the tab overlaps with the open area.

In an embodiment, the open area may have a circular shape.

In an embodiment, a diameter of the open area may be greater than a width of the tab.

In an embodiment, a lower portion of the tab may overlap with the open area.

In an embodiment, the electrode plate may further include a protective tape attached to at least a portion of the composite portion and to the uncoated portion.

In an embodiment, the composite portion may include a first composite portion, a second composite portion, and a third composite portion. The uncoated portion may include: a first uncoated portion between the first composite portion and the second composite portion, and having a first open area; and a second uncoated portion between the second composite portion and the third composite portion, and having a second open area. The tab may include: a first tab coupled to the first uncoated portion; and a second tab coupled to the second uncoated portion. At least a portion of the first tab may overlap with the first open area, and at least a portion of the second tab may overlap with the second open area.

In an embodiment, the open area may include a first open area and a second open area. A first lower portion of the tab may overlap with the first open area, and a second lower portion of the tab may overlap with the second open area.

According to one or more embodiments of the present disclosure, a method of manufacturing an electrode plate, includes: forming a composite portion by applying an active material on at least a portion of a substrate; forming an open area in an uncoated portion in which no active material is applied to the substrate; and coupling a tab to the uncoated portion so that at least a portion of the tab overlaps with the open area.

In an embodiment, the open area may have a circular shape.

In an embodiment, a diameter of the open area may be greater than a width of the tab.

In an embodiment, a lower portion of the tab may overlap with the open area.

In an embodiment, the method may further include attaching a protective tape to at least a portion of the composite portion and to the uncoated portion.

In an embodiment, the composite portion may include a first composite portion, a second composite portion, and a third composite portion. The uncoated portion may include: a first uncoated portion between the first composite portion and the second composite portion; and a second uncoated portion between the second composite portion and the third composite portion. The tab may include a first tab and a second tab. The forming of the open area may include: forming a first open area in the first uncoated portion; and forming a second open area in the second uncoated portion. The coupling of the tab may include: coupling the first tab to the first uncoated portion so that at least a portion of the first tab overlaps with the first open area; and coupling the second tab to the second uncoated portion so that at least a portion of the second tab overlaps with the second open area.

In an embodiment, the forming of the open area may include forming a first open area and a second open area in the uncoated portion. A first lower portion of the tab may overlap with the first open area, and a second lower portion of the tab may overlap with the second open area.

According to one or more embodiments of the present disclosure, a secondary battery includes: an electrode assembly including electrode plates having different polarities from each other, and a separator wound together with the electrode plates; a can accommodating the electrode assembly; and a cap assembly coupled to the can, and connected to the electrode assembly. At least one of the electrode plates includes: a composite portion having an active material applied to a substrate; an uncoated portion in which no active material is applied to the substrate; and a tab coupled to the uncoated portion. The uncoated portion has an open area, and at least a portion of the tab overlaps with the open area.

In an embodiment, the open area may have a circular shape.

In an embodiment, a diameter of the open area may be greater than a width of the tab.

In an embodiment, a lower portion of the tab may overlap with the open area.

In an embodiment, the at least one of the electrode plates may further include a protective tape attached to at least a portion of the composite portion and to the uncoated portion.

In an embodiment, the composite portion may include a first composite portion, a second composite portion, and a third composite portion. The uncoated portion may include: a first uncoated portion between the first composite portion and the second composite portion, and having a first open area; and a second uncoated portion between the second composite portion and the third composite portion, and having a second open area. The tab may include: a first tab coupled to the first uncoated portion; and a second tab coupled to the second uncoated portion. At least a portion of the first tab may overlap with the first open area, and at least a portion of the second tab may overlap with the second open area.

According to some embodiments of the present disclosure, a stress concentration at a lower portion of a tab due to sharp corners of the lower portion of the tab and a rigidity of the tab may be prevented or reduced. As a result, cracking of the electrode plate may be prevented or substantially prevented, thereby improving the safety and the reliability of the secondary battery.

According to some embodiments of the present disclosure, a stress that would otherwise be concentrated at the tabs may be distributed through open areas, thereby allowing a plurality of tabs to be fitted to the electrode plate. Accordingly, a path of electron movement may be optimized or improved by the plurality of tabs, and a higher power may be provided.

These and other aspects and features of the present disclosure will be described in or will be apparent from the following description of embodiments of the present disclosure.

However, aspects and features of the present disclosure are not limited to those described above, and other aspects and features not mentioned will be clearly understood by a person skilled in the art from the detailed description, described below.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 illustrates an example of an electrode plate according to some embodiments of the present disclosure;

FIG. 2 illustrates an example in which a protective tape is attached to an electrode plate according to some embodiments of the present disclosure;

FIG. 3 illustrates a cross-section taken along the line A-A′ of FIG. 2;

FIG. 4 illustrates an example of an open area of an uncoated portion according to some embodiments of the present disclosure;

FIG. 5 illustrates an example of an electrode plate according to some embodiments of the present disclosure;

FIG. 6 illustrates an example of an internal configuration of an electrode assembly according to some embodiments of the present disclosure;

FIG. 7 illustrates example images in which a stress applied to an electrode plate is visualized according to some embodiments of the present disclosure;

FIG. 8 illustrates an example of an electrode plate according to some embodiments of the present disclosure;

FIG. 9 illustrates an example of a method of manufacturing an electrode plate according to some embodiments of the present disclosure; and

FIG. 10 illustrates an example of a secondary battery according to some embodiments of the present disclosure.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when a layer or element is referred to as being “between” two layers, it can be the only layer between the two layers, or one or more intervening layers may also be present. It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C”, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

Embodiments of the present disclosure described herein may be applicable to both a wound electrode assembly and a stacked electrode assembly. The electrodes described herein may be applicable to electrodes included in either the wound electrode assembly or the stacked electrode assembly. The method of manufacturing the electrodes described herein may be applicable to a method of manufacturing electrodes included in either the wound electrode assembly or the stacked electrode assembly.

The dimensions and the relative sizes of the layers and regions shown in the drawings may be exaggerated for convenience of illustration. In other words, the dimensions shown in the drawings are for illustrative purposes, and are not intended to be limiting. In addition, throughout the specification, the same reference numerals designate the same or substantially the same elements.

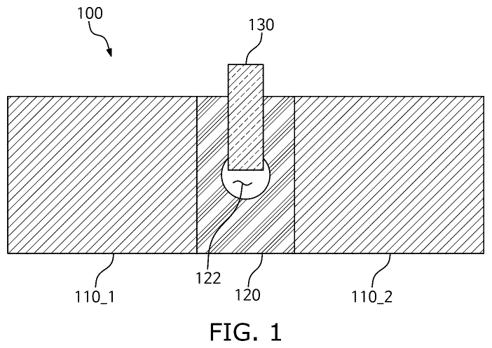

FIG. 1 illustrates an example of an electrode plate 100 according to some embodiments of the present disclosure.

In an embodiment, the electrode plate 100 may include composite portions 110_1 and 110_2 having an active material applied to a substrate, an uncoated portion 120 in which no active material is applied to the substrate, and a tab 130 connected to (e.g., coupled to or attached to) the uncoated portion 120. For example, opposite surfaces of the substrate may be coated with the active material to form the composite portions 110_1 and 110_2 on the opposite surfaces of the substrate. The electrode plate 100 may correspond to a positive electrode plate or a negative electrode plate.

In a case where the electrode plate 100 is a positive electrode plate, the positive electrode substrate may include an aluminum foil, and the positive electrode active material may include, for example, a transition metal oxide. The positive electrode active material may include a compound (lithiated intercalation compound) that is capable of intercalating and deintercalating lithium. Specifically, at least one of a composite oxide of lithium and a metal selected from cobalt, manganese, nickel, and combinations thereof may be used.

The composite oxide may be a lithium transition metal composite oxide. Specific examples of the composite oxide may include lithium nickel-based oxide, lithium cobalt-based oxide, lithium manganese-based oxide, lithium iron phosphate-based compound, cobalt-free nickel-manganese-based oxide, or a combination thereof.

As an example, the following compounds represented by any one of the following Chemical Formulas may be used. LiaA1-bXbO2-cDc (0.90≤a≤1.8, 0≤b≤0.5, and 0≤c≤0.05); LiaMn2-bXbO4-cDc (0.90≤a≤1.8, 0≤b≤0.5, and 0≤c≤0.05); LiaNi1-b-cCobXcO2-αDα(0.90≤a≤1.8, 0≤b≤0.5, 0≤c≤0.5, and 0<α<2); LiaNi1-b-cMnbXcO2-αDα (0.90≤a≤1.8, 0≤b≤0.5, 0≤c≤0.5, and 0<α<2); LiaNibCocL1dGeO2 (0.90≤a≤1.8, 0≤b≤0.9, 0≤c≤0.5, 0≤d≤0.5, and 0≤e≤0.1); LiaNiGbO2 (0.90≤a≤1.8 and 0.001 ≤b≤0.1); LiaCoGbO2 (0.90≤a≤1.8 and 0.001≤b≤0.1); LiaMn1-bGbO2 (0.90≤a≤1.8 and 0.001≤b≤0.1); LiaMn2GbO4 (0.90≤a≤1.8 and 0.001≤b≤0.1); LiaMn1-gGgPO4 (0.90≤a≤1.8 and 0≤g≤0.5); Li(3-f)Fe2(PO4)3 (0≤f≤2); or LiaFePO4 (0.90≤a≤1.8).

In the above Chemical Formulas, A is Ni, Co, Mn, or a combination thereof; X is Al, Ni, Co, Mn, Cr, Fe, Mg, Sr, V, a rare earth element or a combination thereof; D is O, F, S, P, or a combination thereof; G is Al, Cr, Mn, Fe, Mg, La, Ce, Sr, V, or a combination thereof; and L1 is Mn, Al, or a combination thereof.

The positive electrode active material may be, for example, a high nickel-based positive electrode active material having a nickel content of greater than or equal to about 80 mol %, greater than or equal to about 85 mol %, greater than or equal to about 90 mol %, greater than or equal to about 91 mol %, or greater than or equal to about 94 mol % and less than or equal to about 99 mol % based on 100 mol % of the metal excluding lithium in the lithium transition metal composite oxide. The high-nickel-based positive electrode active material may be capable of realizing high capacity and can be applied to a high-capacity, high-density rechargeable lithium battery.

In a case where the electrode plate 100 is a negative electrode plate, the negative electrode substrate may include, for example, a copper foil or a nickel foil, and the negative electrode active material may include, for example, graphite. The negative electrode active material may include a material that reversibly intercalates/deintercalates lithium ions, a lithium metal, a lithium metal alloy, a material capable of doping/dedoping lithium, or a transition metal oxide.

The material that reversibly intercalates/deintercalates lithium ions may include a carbon-based negative electrode active material, such as, for example. crystalline carbon, amorphous carbon or a combination thereof. The crystalline carbon may be graphite such as non-shaped, sheet-shaped, flake-shaped, sphere-shaped, or fiber-shaped natural graphite or artificial graphite. The amorphous carbon may be a soft carbon, a hard carbon, a mesophase pitch carbonization product, calcined coke, and the like.

The lithium metal alloy includes an alloy of lithium and a metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si-based negative electrode active material or a Sn-based negative electrode active material. The Si-based negative electrode active material may include silicon, a silicon-carbon composite, SiOx (0<x<2), a Si-Q alloy (where Q is selected from an alkali metal, an alkaline-earth metal, a Group 13 element, a Group 14 element (excluding Si), a Group 15 element, a Group 16 element, a transition metal, a rare earth element, and a combination thereof). The Sn-based negative electrode active material may include Sn, SnO2, a Sn-based alloy, or a combination thereof.

The silicon-carbon composite may be a composite of silicon and amorphous carbon. According to an embodiment, the silicon-carbon composite may be in a form of silicon particles and amorphous carbon coated on the surface of the silicon particles. For example, the silicon-carbon composite may include a secondary particle (core) in which primary silicon particles are assembled, and an amorphous carbon coating layer (shell) on the surface of the secondary particle. The amorphous carbon may also be between the primary silicon particles, and, for example, the primary silicon particles may be coated with the amorphous carbon. The secondary particle may exist dispersed in an amorphous carbon matrix.

The silicon-carbon composite may further include crystalline carbon. For example, the silicon-carbon composite may include a core including crystalline carbon and silicon particles and an amorphous carbon coating layer on a surface of the core.

The Si-based negative electrode active material or the Sn-based negative electrode active material may be used in combination with a carbon-based negative electrode active material.

In an embodiment, an open area 122 may be provided in (e.g., may penetrate) the uncoated portion 120. The open area 122 may be formed by stamping. At least a portion of the tab 130 may overlap with the open area 122. In more detail, a lower portion of the tab 130 may overlap with the open area 122. The lower portion of the tab 130 may include a corner of the lower portion of the tab 130.

In an embodiment, opposite ends of the tab 130 may be exposed from the uncoated portion 120. A portion of the tab 130 exposed from the uncoated portion 120 may not be in contact with the uncoated portion 120. For example, a first end of the tab 130 may protrude upwardly from the uncoated portion 120 and be exposed from the uncoated portion 120. A second end of the tab 130 may be exposed from the uncoated portion 120 by the open area 122 provided in the uncoated portion 120. A central portion of the tab 130 may be connected to (e.g., coupled to or attached to) the uncoated portion 120. The tab 130 may correspond to a tab formed of a metal, such as nickel or aluminum. The central portion of the tab 130 may be connected to (e.g., coupled to or attached to) the uncoated portion 120 by welding.

In an embodiment, a portion of the corner of the tab 130 may be exposed from the uncoated portion 120. For example, in a case where the tab 130 has four corners, all of the four corners may be exposed from the uncoated portion 120. None of the corners of the tabs 130 exposed from the uncoated portion 120 may be in contact with the uncoated portion 120. In another example, in a case where the tab 130 has four corners, at least three of the corners may be exposed from the uncoated portion 120.

The open area 122 provided in the tab 130 may correspond to a through-hole formed by stamping.

In FIG. 1, the electrode plate 100 is illustrated for a wound battery, with the composite portions 110_1 and 110_2 and the uncoated portion 120 being continuous, but the present disclosure is not limited thereto. For example, in a case where the electrode plate 100 is for a stacked battery, the electrode plate 100 may include one composite portion (e.g., 110_1) and one uncoated portion 120. In this case, the open area 122 may also be provided in the uncoated portion 120, and at least a portion of the tab 130 may be connected to (e.g., coupled to or attached to) the open area 122 to overlap with the same.

In this case, a stress concentration at the lower portion of the tab 130 due to the sharp corners of the lower portion of the tab 130 and the rigidity of the tab 130 may be prevented or reduced. As a result, cracking of the electrode plate 100 may be prevented or substantially prevented, thereby improving the safety and reliability of the secondary battery.

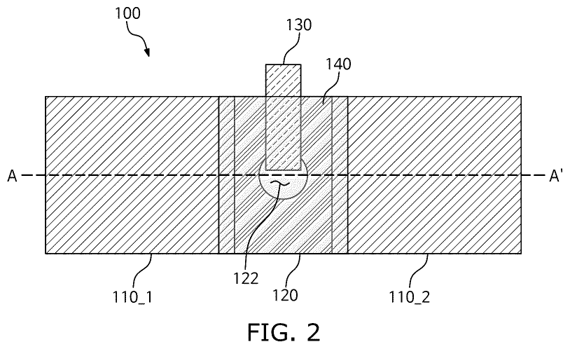

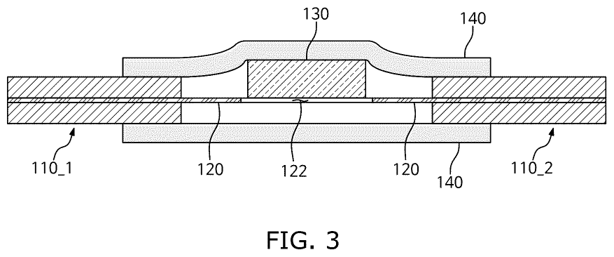

FIG. 2 illustrates an example in which a protective tape 140 is attached to an electrode plate 100 according to some embodiments of the present disclosure. FIG. 3 illustrates a cross-section taken along the line A-A′ of FIG. 2.

In an embodiment, the electrode plate 100 may include composite portions 110_1 and 110_2 having an active material applied to a substrate, an uncoated portion 120 in which no active material is applied to the substrate, a tab 130 connected to (e.g., coupled to or attached to) the uncoated portion 120, and the protective tape 140. The protective tape 140 may be attached to opposite surfaces of the electrode plate 100. The composite portions 110_1 and 110_2 may be provided on opposite surfaces of the substrate.

In an embodiment, the protective tape 140 may be attached to at least a portion of the composite portions 110_1 and 110_2 and to the uncoated portion 120. The protective tape 140 may prevent or substantially prevent a dislodging of the active material of the composite portions 110_1 and 110_2, and may prevent a short-shorting of the tabs 130 connected to (e.g., coupled to or attached to) the uncoated portion 120. In some embodiments, the protective tape 140 may be formed of, but is not limited to, an insulating material. Accordingly, the protective tape 140 may enhance properties of the substrate.

In FIGS. 2 and 3, the protective tape 140 is shown as being attached (e.g., as being only attached) to a portion of the composite portions 110_1 and 110_2, but the present disclosure is not limited thereto.

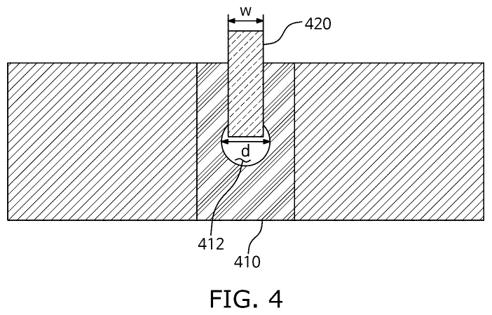

FIG. 4 illustrates an example of an open area 412 of an uncoated portion 410 according to some embodiments of the present disclosure.

In an embodiment, the open area 412 may be provided in the uncoated portion 410. In addition, at least a portion of the tab 420 may overlap with the open area 412. In more detail, a lower portion of the tab 420 may overlap with the open area 412.

In an embodiment, the open area 412 may be circular. In this case, a stress may be uniformly or substantially uniformly distributed within the electrode plate. In addition, a diameter d of the open area 412 may be greater than a width w of the tab 420. Accordingly, a stress may be prevented or substantially prevented from being concentrated at the lower corners of the tab 420.

The open area 412 may have a shape other than the circular shape. For example, the open area 412 may have an elliptical shape. Even in a case where the open area 412 has the elliptical shape, the width of the elliptical shape may be greater than the width w of the tab 420. The shape of the open area 412 may correspond to a shape without a corner. For example, the open area 412 may be rounded throughout portions thereof to prevent or substantially prevent the stress from being concentrated in a specific area. The open area 412 may have a circular, elliptical, or other suitable shape that avoids having corners (e.g., sharp corners), thereby distributing the stress occurring in the electrode plate.

However, the shape of the open area 412 is not limited thereto, and may have any suitable shape in which the width or diameter of the open area 412 is greater than the width w of the tab 420.

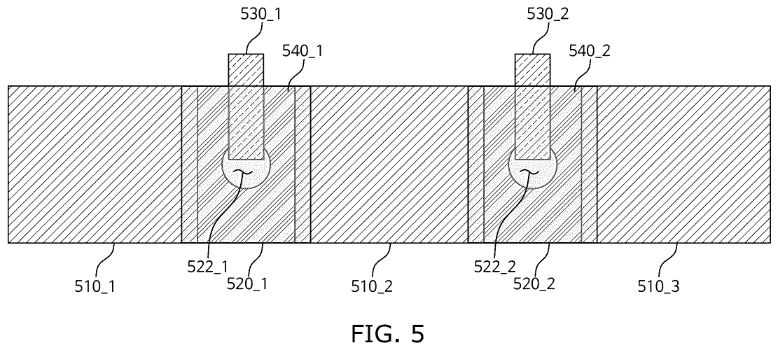

FIG. 5 illustrates an example of an electrode plate according to some embodiments of the present disclosure.

In an embodiment, the electrode plate may include a plurality of tabs 530_1 and 530_2. The electrode plate may include composite portions 510_1 to 510_3 having an active material applied to a substrate, uncoated portions 520_1 and 520_2 in which no active material is applied to the substrate, the tabs 530_1 and 530_2 connected to (e.g., coupled to or attached to) the uncoated portions 520_1 and 520_2, and protective tape 540_1 and 540_2 attached to at least a portion of the composite portions 510_1 to 510_3 and to the uncoated portions 520_1 and 520_2.

In an embodiment, the first uncoated portion 520_1 may be disposed between the first composite portion 510_1 and the second composite portion 510_2. The second uncoated portion 520_2 may be disposed between the second composite portion 510_2 and the third composite portion 510_3. A first open area 522_1 may be provided in (e.g., may penetrate) the first uncoated portion 520_1, and a second open area 522_2 may be provided in (e.g., may penetrate) the second uncoated portion 520_2.

In an embodiment, the first tab 530_1 may be connected to (e.g., coupled to or attached to) the first uncoated portion 520_1. The second tab 540_2 may be connected to (e.g., coupled to or attached to) the second uncoated portion 520_2. In this case, at least a portion of the first tab 530_1 may overlap with the first open area 522_1, and at least a portion of the second tab 530_2 may overlap with the second open area 522_2.

In FIG. 5, the two tabs 530_1 and 530_2 are shown as being connected to (e.g., coupled to or attached to) the uncoated portions 520_1 and 520_2, but the present disclosure is not limited thereto, and additional tabs may be connected to (e.g., coupled to or attached to) the uncoated portions of the electrode plate as needed or desired.

Accordingly, a stress which would have otherwise been concentrated at the tabs 530_1 and 530_2 may be distributed through the open areas 522_1 and 522_2, thereby allowing a plurality of tabs to be fitted to the electrode plate. A path of an electron movement may be optimized or improved by the plurality of tabs, and a higher power may be provided.

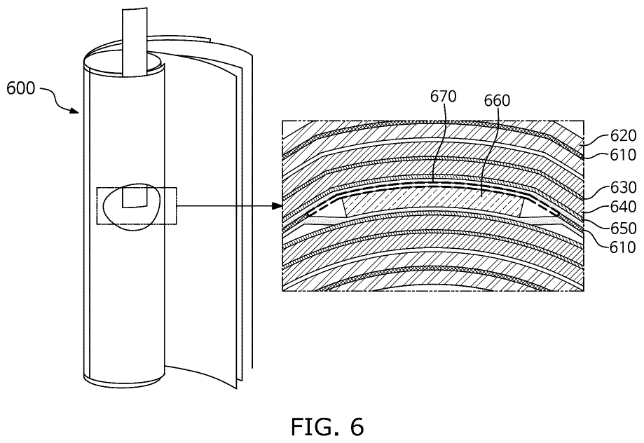

FIG. 6 illustrates an example of an internal configuration of an electrode assembly 600 according to some embodiments of the present disclosure.

In an embodiment, the electrode assembly 600 may be manufactured by winding a positive electrode plate, a negative electrode plate, and a separator 650 provided between the positive electrode plate and the negative electrode plate together. The positive electrode plate may include a positive electrode substrate 610 and a positive electrode active material layer 620. The negative electrode plate may include a negative electrode substrate 630 and a negative electrode active material layer 640.

The separator 650 may include polyethylene, polypropylene, polyvinylidene fluoride, or a multilayer film of two or more layers thereof, and a mixed multilayer film such as a polyethylene/polypropylene two-layer separator, polyethylene/polypropylene/polyethylene three-layer separator, polypropylene/polyethylene/polypropylene three-layer separator, and the like.

The separator 650 may include a porous substrate and a coating layer including an organic material, an inorganic material, or a combination thereof on one or both surfaces of the porous substrate.

The porous substrate may be a polymer film formed of any one selected

polymer polyolefin such as polyethylene and polypropylene, polyester such as polyethylene terephthalate and polybutylene terephthalate, polyacetal, polyamide, polyimide, polycarbonate, polyether ketone, polyarylether ketone, polyether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON, and polytetrafluoroethylene, or a copolymer or mixture of two or more thereof.

The organic material may include a polyvinylidene fluoride-based polymer or a (meth) acrylic polymer.

The inorganic material may include inorganic particles selected from Al2O3, SiO2, TiO2, SnO2, CeO2, MgO, NiO, CaO, GaO, ZnO, ZrO2, Y2O3, SrTiO3, BaTiO3,Mg(OH)2, boehmite, and a combination thereof, but is not limited thereto.

The organic material and the inorganic material may be mixed in one coating layer, or a coating layer including an organic material and a coating layer including an inorganic material may be stacked.

In an embodiment, the electrode plate may include a composite portion having an active material applied to opposite surfaces of a substrate, an uncoated portion in which no active material is applied to the substrate, and a tab connected to (e.g., coupled to or attached to) the uncoated portion. For example, the positive electrode plate may include a composite portion with the positive electrode active material layers 620 applied to opposite surfaces of the positive electrode substrate 610, an uncoated portion with no positive electrode active material applied to the positive electrode substrate 610, and a positive electrode tab 660 connected to (e.g., coupled to or attached to) the uncoated portion. In this case, an open area 670 may be provided in the uncoated portion of the positive electrode plate. The open area 670 is shown as a dashed rectangle in FIG. 6, and may correspond to an empty space in which no substrate is provided.

The open area 670 may overlap with at least a portion of the positive electrode tab 660. In some embodiments, a protective tape may be attached to at least a portion of the composite portion and the uncoated portion. The negative electrode plate may be provided similarly to that of the positive electrode plate.

Only one positive electrode tab 660 is shown on the electrode assembly 600 in FIG. 6, but the present disclosure is not limited thereto, and the electrode assembly 600 may include a plurality of positive electrode tabs. In addition, the electrode assembly 600 may include a negative electrode tab similar to that of the positive electrode tab 660.

In FIG. 6, the electrode assembly 600 is shown as being wound, but the present disclosure is not limited thereto. For example, the electrode assembly may be a Z-stack electrode assembly in which a positive electrode plate and a negative electrode plate are inserted into both sides of a separator, which is then bent into a Z-stack. In addition, one or more electrode assemblies may be stacked such that long sides of the electrode assemblies are adjacent to each other and accommodated in the case, and the number of electrode assemblies in the case is not limited in the present disclosure.

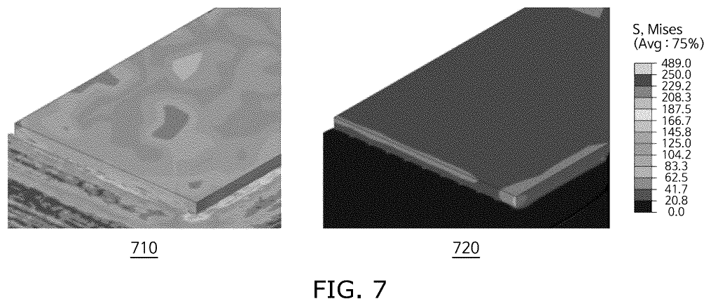

FIG. 7 illustrates example images in which a stress applied to an electrode plate is visualized according to some embodiments of the present disclosure.

In FIG. 7, a first image 710 illustrates an example of a visualization of a stress applied to an electrode plate having a tab connected to (e.g., coupled to or attached to) a comparative uncoated portion. In FIG. 7, a second image 720 illustrates an example of a visualization of a stress applied to an electrode plate having a tab connected to (e.g., coupled to or attached to) an uncoated portion having an open area according to some embodiments of the present disclosure.

Referring to the first image 710, the stress applied to the electrode plate may be non-uniform and relatively high in a case where no open area is provided in the uncoated portion. The first image 710 shows that due to the tab provided on the uncoated portion, the stress is non-uniformly generated over an area corresponding to the uncoated portion.

Referring to the second image 720, in a case where the open area is provided in the uncoated portion, the stress applied to the entire electrode plate may be uniformly or substantially uniformly distributed, and may be reduced by about 7 times. Due to the open area provided in the uncoated portion, the stress may be uniformly or substantially uniformly generated over the area corresponding to the uncoated portion, and may be relatively reduced when compared to the stress illustrated in the first image 710.

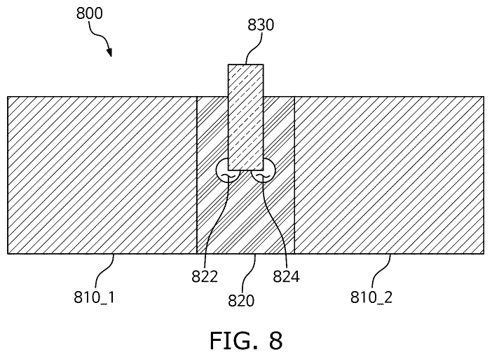

FIG. 8 illustrates an example of an electrode plate 800 according to some embodiments of the present disclosure.

In an embodiment, the electrode plate 800 may include composite portions 810_1 and 810_2 having an active material applied to a substrate, an uncoated portion 820 in which no active material is applied to the substrate, and a tab 830 connected to (e.g., coupled to or attached to) the uncoated portion 820. The electrode plate 800 may correspond to a positive electrode plate or a negative electrode plate.

In an embodiment, a plurality of open areas 822 and 824 may be provided in the uncoated portion 820. In this case, at least a portion of the tab 830 may overlap with the open areas 822 and 824. In more detail, a first lower portion (e.g., a first corner) of the tab 830 may overlap with the first open area 822, and a second lower portion (e.g., a second corner) of the tab 830 may overlap with the second open area 824. The first lower portion and the second lower portion may be different from each other. In some embodiments, a center point of each of the open areas 822 and 824 may coincide with an apex of the corresponding lower corner of the tab 830.

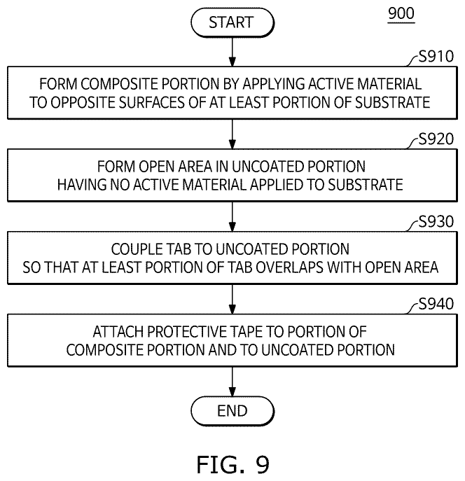

FIG. 9 illustrates an example of a method 900 of manufacturing an electrode plate according to some embodiments of the present disclosure.

In an embodiment, the method 900 may start, and a composite portion may be formed by applying an active material to at least a portion (e.g., such as to opposite surfaces) of a substrate (S910). The composite portion may be formed on a single surface or on the opposite surfaces of the substrate. An open area may be formed in an uncoated portion having no active material applied to the substrate (S920). In this case, the open area may be formed by a stamping process. For example, in a case where the electrode plate moves in a horizontal direction, a hole-forming stamping apparatus may stamp at least a portion of the uncoated portion by a vertical movement.

The tab may be connected to (e.g., coupled to or attached to) the uncoated portion so that at least a portion of the tab overlaps with the open area (S930). In more detail, a lower portion of the tab may overlap with the open area. In addition, the open area may be circular. In this case, the diameter of the open area may be greater than the width of the tab. Subsequently, a protective tape may be attached to at least a portion of the composite portion and to the uncoated portion (S940), and the method 900 may end.

In an embodiment, the composite portion may include a first composite portion, a second composite portion, and a third composite portion. In addition, the uncoated portion may include a first uncoated portion disposed between the first composite portion and the second composite portion, and a second uncoated portion disposed between the second composite portion and the third composite portion. In this case, a first tab may be connected to (e.g., coupled to or attached to) the first uncoated portion, and a second tab may be connected to (e.g., coupled to or attached to) the second uncoated portion.

In an embodiment, a first open area and a second open area of the uncoated portion may be formed. In this case, a first lower portion of the tab may overlap with the first open area, and a second lower portion of the tab may overlap with the second open area. The first lower portion and the second lower portion may be different from each other.

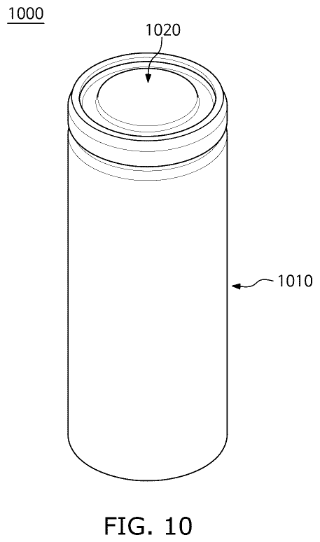

FIG. 10 illustrates an example of a secondary battery 1000 according to some embodiments of the present disclosure.

In an embodiment, the secondary battery 1000 may include an electrode assembly including a separator, and electrode plates having different polarities from each other (e.g., a jelly roll manufactured by winding the separator and electrode plates together). The secondary batter 1000 may further include a can 1010 accommodating the electrode assembly, and a cap assembly 1020 connected to (e.g., coupled to or attached to) the can 1010 and connected to the electrode assembly. The electrode plate within the electrode assembly may include a composite portion having an active material applied to opposite surfaces of a substrate, an uncoated portion in which no active material is applied to the substrate, and a tab connected to (e.g., coupled to or attached to) the uncoated portion. In some embodiments, the electrode plate may further include a protective tape attached to at least a portion of the composite portion and to the uncoated portion.

In an embodiment, an open area may be formed in the uncoated portion. The open area may be circular. In this case, the diameter of the open area may be greater than the width of the tab.

In an embodiment, at least a portion of the tab may overlap with the open area. In more detail, a lower portion of the tab may overlap with the open area. The open area may include a first open area and a second open area. In this case, the first lower portion of the tab may overlap with the first open area, and the second lower portion of the tab may overlap with the second open area. The first lower portion and the second lower portion may be different from each other.

In an embodiment, the composite portion may include a first composite portion, a second composite portion, and a third composite portion. In some embodiments, the uncoated portion may include a first uncoated portion disposed between the first composite portion and the second composite portion, and a second uncoated portion disposed between the second composite portion and the third composite portion. In this case, the tab may include a first tab connected to (e.g., coupled to or attached to) the first uncoated portion, and a second tab connected to (e.g., coupled to or attached to) the second uncoated portion.

Although the present disclosure has been described above with respect to embodiments thereof, the present disclosure is not limited thereto. Various modifications and variations can be made thereto by those skilled in the art within the spirit of the present disclosure and the equivalent scope of the appended claims.

### DESCRIPTION OF SOME REFERENCE SYMBOLS

100: electrode plate
110: composite portion
120: uncoated portion
122: open area
130: tab
140: protective tape
410: uncoated portion
412: open area
420: tab
510_1: first composite portion
510_2: second composite portion
510_3: third composite portion
520_1: first uncoated portion
520_2: second uncoated portion
600: electrode assembly
610: positive electrode substrate
620: positive electrode active material
630: negative electrode substrate
640: negative electrode active material

What is claimed is:

1. An electrode plate comprising:
a composite portion comprising an active material applied to a substrate;
an uncoated portion in which no active material is applied to the substrate; and
a tab coupled to the uncoated portion,
wherein the uncoated portion has an open area, and
wherein at least a portion of the tab overlaps with the open area.

2. The electrode plate as claimed in claim 1, wherein the open area has a circular shape.

3. The electrode plate as claimed in claim 2, wherein a diameter of the open area is greater than a width of the tab.

4. The electrode plate as claimed in claim 1, wherein a lower portion of the tab overlaps with the open area.

5. The electrode plate as claimed in claim 1, further comprising a protective tape attached to at least a portion of the composite portion and to the uncoated portion.

6. The electrode plate as claimed in claim 1, wherein the composite portion comprises a first composite portion, a second composite portion, and a third composite portion,
wherein the uncoated portion comprises:
a first uncoated portion between the first composite portion and the second composite portion, and having a first open area; and
a second uncoated portion between the second composite portion and the third composite portion, and having a second open area,
wherein the tab comprises:
a first tab coupled to the first uncoated portion; and
a second tab coupled to the second uncoated portion, and
wherein at least a portion of the first tab overlaps with the first open area, and at least a portion of the second tab overlaps with the second open area.

7. The electrode plate as claimed in claim 1, wherein the open area comprises a first open area and a second open area, and
wherein a first lower portion of the tab overlaps with the first open area, and a second lower portion of the tab overlaps with the second open area.

8. A method of manufacturing an electrode plate, the method comprising:
forming a composite portion by applying an active material on at least a portion of a substrate;
forming an open area in an uncoated portion in which no active material is applied to the substrate; and
coupling a tab to the uncoated portion so that at least a portion of the tab overlaps with the open area.

9. The method as claimed in claim 8, wherein the open area has a circular shape.

10. The method as claimed in claim 9, wherein a diameter of the open area is greater than a width of the tab.

11. The method as claimed in claim 8, wherein a lower portion of the tab overlaps with the open area.

12. The method as claimed in claim 8, further comprising attaching a protective tape to at least a portion of the composite portion and to the uncoated portion.

13. The method as claimed in claim 8, wherein the composite portion comprises a first composite portion, a second composite portion, and a third composite portion,
wherein the uncoated portion comprises:
a first uncoated portion between the first composite portion and the second composite portion; and
a second uncoated portion between the second composite portion and the third composite portion,
wherein the tab comprises a first tab and a second tab,
wherein the forming of the open area comprises:
forming a first open area in the first uncoated portion; and
forming a second open area in the second uncoated portion, and
wherein the coupling of the tab comprises:
coupling the first tab to the first uncoated portion so that at least a portion of the first tab overlaps with the first open area; and
coupling the second tab to the second uncoated portion so that at least a portion of the second tab overlaps with the second open area.

14. The method as claimed in claim 8, wherein the forming of the open area comprises forming a first open area and a second open area in the uncoated portion, and
wherein a first lower portion of the tab overlaps with the first open area, and a second lower portion of the tab overlaps with the second open area.

15. A secondary battery comprising:
an electrode assembly comprising electrode plates having different polarities from each other, and a separator wound together with the electrode plates;
a can accommodating the electrode assembly; and
a cap assembly coupled to the can, and connected to the electrode assembly,
wherein at least one of the electrode plates comprises:
a composite portion having an active material applied to a substrate;
an uncoated portion in which no active material is applied to the substrate; and
a tab coupled to the uncoated portion, and
wherein the uncoated portion has an open area, and at least a portion of the tab overlaps with the open area.

16. The secondary battery as claimed in claim 15, wherein the open area has a circular shape.

17. The secondary battery as claimed in claim 15, wherein a diameter of the open area is greater than a width of the tab.

18. The secondary battery as claimed in claim 15, wherein a lower portion of the tab overlaps with the open area.

19. The secondary battery as claimed in claim 15, wherein the at least one of the electrode plates further comprises a protective tape attached to at least a portion of the composite portion and to the uncoated portion.

20. The secondary battery as claimed in claim 15, wherein the composite portion comprises a first composite portion, a second composite portion, and a third composite portion,
wherein the uncoated portion comprises:
a first uncoated portion between the first composite portion and the second composite portion, and having a first open area; and
a second uncoated portion between the second composite portion and the third composite portion, and having a second open area,
a first tab coupled to the first uncoated portion; and
a second tab coupled to the second uncoated portion, and
wherein at least a portion of the first tab overlaps with the first open area, and at least a portion of the second tab overlaps with the second open area.
